(19) United States
(12) Patent Application Publication
(10) Pub. No.: US 2010/0227189 A1
(43) Pub. Date: Sep. 9, 2010

(54) Method of Synthesizing Metal Nanoparticles Using 9-Borabicyclo [3.3.1] Nonane (9-BBN) as a Reducing Agent

(76) Inventors: Jennifer S. Shumaker-Parry, Salt Lake City, UT (US); Rajesh Sardar, Carrboro, NC (US); Patrick M. Shem, Salt Lake City, UT (US)

Correspondence Address: THORPE NORTH & WESTERN, LLP., P.O. Box 1219, SANDY, UT, 84091-1219, US

(21) Appl. No.: 12/720,000

(22) Filed: Mar. 9, 2010

Related U.S. Application Data
(60) Provisional application No. 61/158,576, filed on Mar. 9, 2009.

(51) Int. Cl. B32B 15/02; B22F 9/00; B22F 1/02

(52) U.S. Cl. 428/570; 75/343

(57) ABSTRACT

A method of synthesizing ligand-capped metal nanoparticles is disclosed and described. A method of synthesizing ligand-capped metal nanoparticles can comprise reacting a metal salt with 9-borabicyclo [3.3.1] nonane as a reducing agent in the presence of a capping ligand to form the ligand-capped metal nanoparticles. The method can be a single step approach which also significantly broadens choices for capping agents which can be readily incorporated during formation of the metal nanoparticles.

### RELATED APPLICATIONS

This application claims the benefit of U.S. Provisional Patent Application No. 61/158,576, filed Mar. 9, 2009 and which is incorporated herein by reference.

### BACKGROUND

Different wet-chemical synthetic methods have emerged for the generation of nanometer-scale metal particles which display size, shape, and organization dependent optical properties that are exploited in a wide range of fields. For example, the synthesis of monodisperse gold nanoparticles (AuNPs) with average diameters of <5.0 nm is one of the major challenges in nanotechnology research. The narrow particle size dispersion is essential for controlling the properties of the materials for applications, specifically in nanoscale device development. Typically, the Brust two-phase synthetic approach is used to generate monodisperse gold nanoparticles. However, this approach requires phase transfer agents, which introduces impurities in the synthesized particles and requires extra purification steps. In addition, the types of ω-functionalized alkylhiols that may be used as stabilizing ligands in the synthesis are limited. Additionally, single-step approaches have been developed for the generation of monodisperse AuNPs. Although these approaches eliminate the need for phase transfer, the reduction processes are only compatible with nonfunctionalized alkylamine or alkylthiol capping ligands used for stabilization of the nanoparticles.

As such, ongoing research and developmental efforts continue in the field of monodisperse metal nanoparticles.

### SUMMARY

In light of the problems and deficiencies noted above, a method of synthesizing ligand-capped metal nanoparticles can comprise reacting a metal salt with 9-borabicyclo [3.3.1] nonan as a reducing agent in the presence of a capping ligand to form the metal nanoparticles.

In another embodiment, a collection of metal nanoparticles can comprise a plurality of metal nanoparticles functionalized with at least one capping ligand selected from the group consisting of alkyl thiols, azide disulfides, phosphines, bipyridines, and combinations thereof.

There has thus been outlined, rather broadly, the more important features of the invention so that the detailed description thereof that follows may be better understood, and so that the present contribution to the art may be better appreciated. Other features of the present invention will become clearer from the following detailed description of the invention, taken with the accompanying drawings and claims, or may be learned by the practice of the invention.

### BRIEF DESCRIPTION OF THE DRAWINGS

The present invention will become more fully apparent from the following description and appended claims, taken in conjunction with the accompanying drawings. Understanding that these drawings merely depict exemplary embodiments of the present invention and they are, therefore, not to be considered limiting of its scope. It will be readily appreciated that the components of the present invention, as generally described and illustrated in the figures herein, could be arranged, sized, and designed in a wide variety of different configurations. Nonetheless, the invention will be described and explained with additional specificity and detail through the use of the accompanying drawings in which:

FIG. 1 is a reaction scheme showing 9-BBN induced single step synthesis of alkylthiol stabilized gold nanoparticles in accordance with one embodiment;

FIG. 2 is a UV-visible absorption spectra of octadecanethiol (ODT) capped gold nanoparticles (AuNPs) at different time intervals in accordance with one embodiment;

FIG. 3A is a TEM image of ODT-stabilized AuNPs with an inset TEM image at higher magnification with a 40 nm scale bar in accordance with one embodiment;

FIG. 3B is a histogram of particle size analysis of the particles produced and pictured in FIG. 1A in accordance with one embodiment;

FIG. 4 is a UV-visible absorption spectra of AuNPs in the presence of different ω-functionalized alkylthiols in accordance with another embodiment;

FIG. 5A is a TEM image of 11-mercaptoundecanoic acid (MUA) thiol capped AuNPs with scale bar of 40 nm in accordance with one embodiment;

FIG. 5B is a TEM image of 11-mercaptoundecanamide (MUDA) thiol capped AuNPs with scale bar of 40 nm in accordance with one embodiment;

FIG. 5C is a TEM image of azide-terminated undecyl disulfide (AUDDS) thiol capped AuNPs with scale bar of 40 nm in accordance with one embodiment;

FIG. 6 is a TEM image 11-mercapto-1-undecanoic acid (MUOH) capped AuNPs in accordance with another embodiment;

FIG. 7 is a graph of transmittance versus wavenumber for three different metal nanoparticles in accordance with one embodiment;

FIG. 8A is a TEM image of ligand stabilized Ag with scale bar at 60 nm in accordance with one embodiment;

FIG. 8B is a TEM image of ligand stabilized Pd with scale bar at 60 nm in accordance with one embodiment;

FIG. 8C is a TEM image of ligand stabilized Pt with scale bar at 60 nm in accordance with one embodiment;

FIG. 9A-D are UV-visible absorption spectra of (A) silver nanoparticles (AgNPs) and (C) palladium nanaoparticles (PdNPs) and histogram of particle size analysis for (B) AgNPs and (D) PdNPs in accordance with one embodiment;

FIG. 10 (A) UV-visible absorption spectra of triphenylphosphine (TPP)-stabilized AuNPs synthesized at different temperatures and (B) TEM image of TPP-stabilized AuNPs synthesized at room temperature in accordance with one embodiment;

FIG. 11 is a reaction scheme for a synthetic pathway for TTP-stabilized AuNPs in accordance with one embodiment;

FIG. 12 is an X-ray photoelectron spectra (XPS) of TPP-stabilized AuNPs synthesized at room temperature in accordance with one embodiment;

FIG. 13 is a ³¹P nuclear magnetic resonance (NMR) spectra for pure TPP and TPP-AuNPs in accordance with one embodiment;

FIG. 14 is a ¹H NMR spectra for TPP-AuNPs in accordance with one embodiment;

FIG. 15 are TEM images of TPP stabilized AuNPs synthesized at different temperatures, (A) 40° C. and (B) 50° C., respectively.

FIG. 16 is a reaction scheme showing a ligand exchange of TPP of TPP-AuNPs with MUA capping ligands and dodecanethiol (DDT) capping ligands in accordance with one embodiment;

FIG. 17 are TEM images of (A) DDT, (B) MUA stabilized AuNPs with scale bars are 70 nm in accordance with one embodiment and (C) MUOH stabilized AuNPs; and

FIG. 18 is a UV-visible absorption spectra, and TEM image of TOP stabilized 2.8±0.7 nm AuNPs in accordance with one embodiment.

### DETAILED DESCRIPTION

The following detailed description of exemplary embodiments of the invention makes reference to the accompanying drawings, which form a part hereof and in which are shown, by way of illustration, exemplary embodiments in which the invention may be practiced. While these exemplary embodiments are described in sufficient detail to enable those skilled in the art to practice the invention, it should be understood that other embodiments may be realized and that various changes to the invention may be made without departing from the spirit and scope of the present invention. Thus, the following more detailed description of the embodiments of the present invention is not intended to limit the scope of the invention, as claimed, but is presented for purposes of illustration only and not limitation to describe the features and characteristics of the present invention, to set forth the best mode of operation of the invention, and to sufficiently enable one skilled in the art to practice the invention. Accordingly, the scope of the present invention is to be defined solely by the appended claims.

The following detailed description and exemplary embodiments of the invention will be best understood by reference to the accompanying drawings, wherein the elements and features of the invention are designated by numerals throughout.

### DEFINITIONS

In describing and claiming the present invention, the following terminology will be used.

The singular forms “a,” “an,” and “the” include plural referents unless the context clearly dictates otherwise. Thus, for example, reference to “a particle” includes reference to one or more of such materials and reference to “reacting” refers to one or more such steps.

As used herein, “ω functionalized” refers to the position of a functional group on a ligand as being in the last position; i.e., on the unattached end of the ligand. For example, with reference to thiol ligands, the functional group would be at one end of the ligand with the thiol group at the other end of the ligand.

As used herein, “ligand” generally refers to organic compounds with a MW of less than 1500, in some cases about 1000 or less. In one aspect, the ligand can be a non-polymeric organic compound.

As used herein with respect to an identified property or circumstance, “substantially” refers to a degree of deviation that is sufficiently small so as to not measurably detract from the identified property or circumstance. The exact degree of deviation allowable may in some cases depend on the specific context.

As used herein, a plurality of items, structural elements, compositional elements, and/or materials may be presented in a common list for convenience. However, these lists should be construed as though each member of the list is individually identified as a separate and unique member. Thus, no individual member of such list should be construed as a de facto equivalent of any other member of the same list solely based on their presentation in a common group without indications to the contrary.

Concentrations, amounts, and other numerical data may be presented herein in a range format. It is to be understood that such range format is used merely for convenience and brevity and should be interpreted flexibly to include not only the numerical values explicitly recited as the limits of the range, but also to include all the individual numerical values or sub-ranges encompassed within that range as if each numerical value and sub-range is explicitly recited. For example, a numerical range of about 1 to about 4.5 should be interpreted to include not only the explicitly recited limits of 1 to about 4.5, but also to include individual numerals such as 2, 3, 4, and sub-ranges such as 1 to 3, 2 to 4, etc. The same principle applies to ranges reciting only one numerical value, such as “less than about 4.5,” which should be interpreted to include all of the above-recited values and ranges. Further, such an interpretation should apply regardless of the breadth of the range or the characteristic being described.

Any steps recited in any method or process claims may be executed in any order and are not limited to the order presented in the claims. Means-plus-function or step-plus-function limitations will only be employed where for a specific claim limitation all of the following conditions are present in that limitation: a) “means for” or “step for” is expressly recited; and b) a corresponding function is expressly recited. The structure, material or acts that support the means-plus function are expressly recited in the description herein. Accordingly, the scope of the invention should be determined solely by the appended claims and their legal equivalents, rather than by the descriptions and examples given herein.

Nanoparticle Formation using 9-BBN as a Reducing Agent

A metal salt can be reacted with 9-borabicyclo [3.3.1] nonan (9-BBN) which acts as a reducing agent in the presence of a capping ligand to form ligand-capped metal nanoparticles. The metal salt can be a metal salt of any suitable metal. Non-limiting examples of suitable metal salts can include gold salts, palladium salts, platinum salts, silver salts, and combinations thereof. The reduction methodology can also be applicable for other transition or early transition metals such as copper, cobalt, nickel, iridium, ruthenium, rhodium, osmium and iron nanoparticles synthesis.

Suitable gold salts can include, but are not limited to, Et₃PAuCl, gold halides (AuX, X═Cl⁻, Br⁻, and I⁻), gold cyanide, and combinations thereof. The gold halides can include gold chloride, gold bromide, gold iodide, combinations thereof, and mixtures thereof. Similarly, suitable palladium salts can include palladium acetate, palladium chloride, tetrachloropalladate, and combinations thereof. Suitable platinum salts can include, but are in no way limited to, potassium tetrachloroplatinate(II), hexachloroplatinic(IV) acid hydrate, platinum chloride, and combinations thereof. Although other silver salts can be suitable, examples include silver heptafluorobutyrate, silver trifluoroacetate, silver acetate, and combinations thereof.

The methods offer a one step process for producing ligand-capped metal nanoparticles. As such, a capping ligand can be present during the formation of the metal nanoparticles such that incorporation of the capping ligands onto nanoparticle surfaces is accomplished in situ. Furthermore, the use of 9-BBN as the reducing agent dramatically increases the number of possible functional groups and capping ligands which can be used. Suitable capping ligands can provide dispersion stability, can provide reactive binding sites, can provide moieties for further processing, can change or tailor properties (e.g. optical or electrical properties), and/or can be used for other purposes. Non-limiting examples of suitable classes of capping ligands include functionalized alkyl thiols, azide disulfides, phosphines, bipyridines, and combinations thereof.

In one aspect, the capping ligand can include an ω-functionalized group. When the capping ligand is a functionalized alkyl thiol, the ω-functionalized group can typically be an acid, amide, alcohol, or azide. For example, the ω-functionalized group can be CH₃, COOH, OH, CONH₂, N₃, quaternary ammonium thiolate, ferrocene, and combinations thereof, although other groups may be suitable. Non-limiting examples of suitable alkylthiols include octadecanethiol, dodecanethiol, 11-mercaptoundecanoic acid (MUA), 11-mercapto-1-undecanoic acid (MUOH), 11-mercaptoundecanamide (MUDA), and the like. The ω-functionalized alkylthiols can be represented as HS—(CH₂)ₙ—X, where n can be from 6 to 17 and X can be —CH₃, —OH, —COOH, —CONH₂, —N₃, -Fc (ferrocene), or —NEt₃. Suitable azide disulfides can include azide-terminated undecyl disulfide (AUDDS). Non-limiting examples of suitable phosphines include triphenylphosphine, trioctylphosphine and other optically active phosphine compounds, such as (S)-2,2′-bis(diphenylphosphino)-1,1′-binaphthyl [(S)-BINAP], (R)-2,2′-bis(diphenylphosphino)-1,1′-binaphthyl [(R)-BINAP], (2R,3R)-(+2,3-Bis(diphenylphosphino)-bicyclo[2.2.1]hept-5-ene [(R,R)—NORPHOS], (−)-2,2-Dimethyl-4,5-((diphenylphosphino)dimethyl)dioxolane [(R,R)-DIOP] and (+)-2,2-Dimethyl-4,5-((diphenylphosphino)dimethyl)dioxolane [(S,S)-DIOP]. Suitable bipyridines and dithiols can include, but are not limited to, 2,2′ bipyridyl, 2,4′ bipyridyl and 4,4′ bipyridyl, 2,2′-bithiophene and Bis(ethylenedithio) tetrathiafulvalene (BEDT-TTF).

The choice of ligands can be made in such a way that further chemistry can be readily facilitated. For example, attachment of various redox functionalities to nanoparticle surfaces by amide or ester formation or azide “click chemistry” can be achieved.

Additionally, synthesis of the metal nanoparticles can include a stabilizing diluent to stabilize the nanoparticles in a solution. Any conventional solvent stabilized systems can be used. For example, stabilizing diluents can include tetrahydrofuran (THF), acetonitrile (CH₃CN), and toluene. The ability to create solvent stabilized particles can facilitate activity of the particles in catalysis. This is because molecules have access to the surface of the nanoparticles which is where the catalytic activity takes place. If the particles are completely surrounded by a stabilizing agent, access to the surface is reduced.

In conjunction with the 9-BBN, it has been found that the addition of a catalyst can further enhance the method. In one aspect, the catalyst is trioctylamine, but other amine compounds can also be used.

The resulting collection of metal nanoparticles can be substantially monodisperse and can be tailored for a wide variety of specific applications, depending on the capping ligands chosen. The surface plasmon resonance (SPR) based optical properties can also be tuned depending on the reaction conditions and selection of capping ligands. Additionally, the metal nanoparticles can be used in imaging devices, catalysis and nanoelectronics. In one aspect, the metal nanoparticles can be used in photonics applications related to energy capture and transformation (photovoltaics) e.g. nanophotonics. Another application can be therapeutics based on optical properties and/or as a non-toxic carrier for other therapeutics. Furthermore, fluorophores, or redox molecules can be attached to the nanoparticles through chemical bonding with nanoparticles surface bound ligand, and can be used in detection systems. Bio-molecules, such as protein or lipid can also be attached to the nanoparticles through electrostatic binding and has useful applications in bio-molecular detection systems.

Generally, the present invention generates relatively small size (<5.0 nm) dispersed nanoparticles by reduction of metal salts with a mild reducing agent in the presence of a capping ligand. Additionally, in the presence of stabilizing agents, the slow reduction can lead to better control over the particle growth process and generate nearly monodisperse nanoparticles. In addition, by using a mild reducing agent, a wide variety of functional groups could be incorporated as stabilizing ligands during synthesis. However, not all mild reducing agents can provide consistent results or sufficient reducing activity.

Synthesis of small size (<5.0 nm) nearly monodispersed metal nanoparticles are a particular field of interest due to their applications in various catalytic reactions, implementation of nanoscale devices, organic or biomolecules sensing, and intrusing optical properties which leads applications in optical based detection system. As previously discussed, Brust two-phase methods and its various modifications have been commonly used to synthesize small size nearly monodisperse metal nanoparticles. Although the methods have shown great success in the synthesis prospect, the required phase transfer agent eventually introduces impurities in the final products, which are difficult to remove, requiring vigorous cleaning steps, which may not completely remove the impurities. Additionally the synthesis is performed in the presence of non-functional alkylthiols, as a result for the above mentioned applications, ligand (place) exchange reactions are compulsory to achieve surface functionalized nanoparticles. As such, the present inventors have discovered a method of synthesizing metal nanoparticles in the presence of functionalized ligands and/or diluent.

A simple synthetic route where gold (Au) and other nanoparticles, e.g., (Ag, Pd, and Pt), can be synthesized in the presence of ω-functionalized alkylthiols. In the synthetic method, alkylthiols can contain acid, amide, alcohol functional groups and azide terminated disulfide. As discussed in further detail below, 9-borabicyclo [3.3.1] nonane (9-BBN) was used as a reducing in the synthesis of noble metal nanoparticles. Simple tuning of the reaction conditions can yield gold nanoparticles with average diameter 1.1-4.0 nm range. For example, tuning can be accomplished by adjusting the molar ratios of the reducing agent/metal salt, varying the types of capping ligands, and the procedure related to stirring the solution during the reaction. In one embodiment, the nanoparticle size can be decreased by increasing the temperature or increased by decreasing the temperature (e.g. from about 0° C. to about 100° C., although other temperatures can be used by choosing a solvent having a boiling point above the reaction temperature).

The reduction methodology can also be extended in order to synthesize narrowly dispersed gold nanoparticles, or other metal nanoparticles, which can be capped with various phosphine ligands. The triphenylphosphine (TPP) stabilized AuNPs can be monodisperse in nature and have various sizes. For example, 1.4 and 1.2 nm of TPP capped AuNPs can be synthesized and redispersed either in organic or aqueous solvent.

The mild reducing character of 9-BBN can also help to prepare solvent stabilized AuNPs, and other metal nanoparticles, which can be furthered functionalized with alkylthiols having various chain lengths. The thiol stabilized AuNPs, as well as other metal nanoparticles, can display interesting optical properties in their near-field region and depending on the chain length of thiols, the surface plasmon resonance (SPR) wavelengths. For example, the surface plasmon resonance and energy absorbance can vary from ultraviolet to near infrared, and in one aspect between 542-560 nm. NIR absorbance can be used for photonics (e.g. absorption of longer wavelength light for solar applications) and for medical applications (e.g. imaging) due to the ability to penetrate some distance into biological tissue.

The methods of the present invention can be a single step approach with the use of inexpensive reagents. The absence of a phase transfer agent makes the method simple, inexpensive and straight-forward and the synthesized particles are ready to use without further purification. Various ω-functionalized alkylthiols can be used in the in-situ synthesis which eventually helps to achieve acid, amide or alcohol functional groups or azide terminated disulfide containing metal nanoparticles. Furthermore, there is no need for the place exchange reactions which are basically the most conventional way to generate functional nanoparticles. The nearly monodisperse particles can be synthesized either in organic or aqueous medium. For example, a single step synthesis of TPP stabilized AuNPs by the methods described herein does not require vigorous cleaning steps which are essential in the method of the prior art including the conventional Brust method.

Further, with water soluble capping ligands, the water soluble particles can be used directly in nano-biotechnology research without any surface modification steps. Although phosphine-stabilized gold nanoparticles are commercially available as biological taggants for electron microscopy, they are too expensive for most applications. For example, non-reactive 1.4-nm gold particles (Nanogold) are available from Nanoprobes, Inc. (http://nanoprobes.com) at a current price of is $163/30 nmol (as of 10/08).

In addition to achieving small sized nanoparticles, the present methods can provide substantially uniformity in size; i.e., low size dispersion (<10%) without post-synthesis processing.

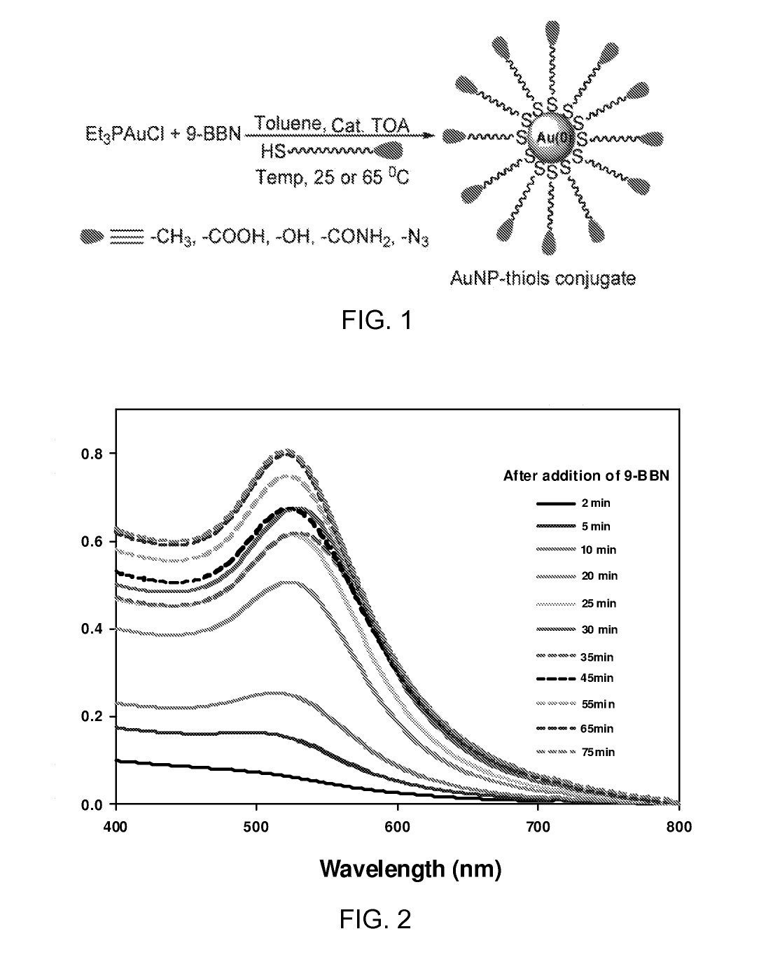

In one embodiment, this mild reduction process can be exploited for in situ synthesis of various ω-functionalized (acid, amide, or alcohol) alkylthiol or azide terminated disulfide-protected AuNPs as shown in FIG. 1. The methodology can also be used in the synthesis of Ag, Pd, and Pt nanoparticles, or other metal nanoparticles. As shown in FIG. 1., the alkylthiol stabilized gold nanoparticles were synthesized at room temperature or 60° C. via a single step reduction process.

Small metal clusters of nanoparticles can serve as building blocks for two or three-dimensional super-lattice formation and in organic or biomolecules detection. For example, AuNPs-phosphine conjugates can serve as staining agents in different biological systems especially in immuno-assay or labeling. The phosphine stabilized AuNPs can also be used as efficient catalysts in asymmetric reaction. Another advantage of using phosphine ligands as stabilizers is that the phosphine molecules can be easily replaced by thiolated surfactants from the nanoparticle surface making the particles accessible in aqueous medium which can enhance their applications in nano-biotechnology.

### EXAMPLES

The following examples illustrate embodiments of the invention that are presently known. Thus, these examples should not be considered as limitations of the present invention, but are merely in place to teach how to make compositions of the present invention. As such, a representative number of compositions and their method of manufacture are disclosed herein.

### Example 1

### Synthesis of Ligand-Capped Gold Nanoparticles

(A) ODT-Capped Gold Nanaparticles

In the synthetic approach, 0.017 g (0.05 mmol) of Et₃PAuCl was dissolved in 100 mL of toluene. The solution was stirred for 5 min, then 0.17 mL (0.5 mmol) of 1-octadecanethiol (ODT) was injected, and stirring was continued for another 30 min. Next, 0.2 mL of 0.5 M 9-BBN in THF was added followed by immediate injection of 0.005 mL (0.01 mmol) of trioctylamine (TOA). The color of the solution gradually changed from orange to light purple. At 65 min, the solution color was reddish-purple and exhibited a stable λₘₐₓ at 520 nm. No further absorption changes were observed (FIG. 2).

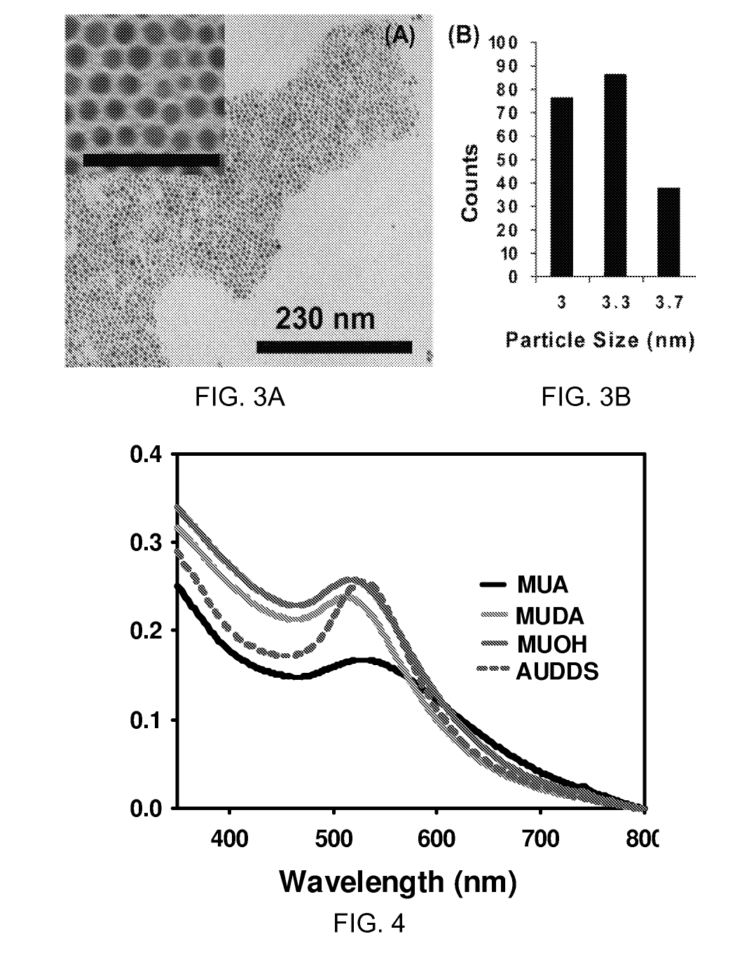

The final solution collected 65 min after addition of 9-BBN was analyzed by transmission electron microscopy (TEM) to determine the particle size, size distribution, and organization. The TEM analysis shows nearly monodisperse particles with an average diameter of 3.3 nm±0.3 nm (FIG. 3B). In addition, the particles formed highly ordered two-dimensional (2-D) arrays on the TEM grid as shown in FIG. 3A.

(B) MUA-Capped Gold Nanaparticles

In another synthetic procedure, 0.017 g (0.05 mmol) of Et₃PAuCl was dissolved in 100 mL of toluene in air at room temperature. The solution was stirred for 5 min, and at this point 0.066 g (0.3 mmol) of 11-mercaptoundecanoic acid (MUA) was added and stirring was continued for another 30 min. The solution was heated until the temperature reached 60° C. At this point, 0.6 mL of 0.5 M 9-BBN in THF and 0.010 mL (0.02 mmol) of TOA were added to the reaction mixture. Immediately after addition of 9-BBN, the color of the solution changed to orange followed by light purple, and within 10 min it was a reddish-purple colored suspension. The solution was heated for another 10 min, then removed from heat, and stirred at room temperature for 30 min. The solution was centrifuged resulting in a reddish-purple colored solid. The solid was dried under nitrogen for further analysis.

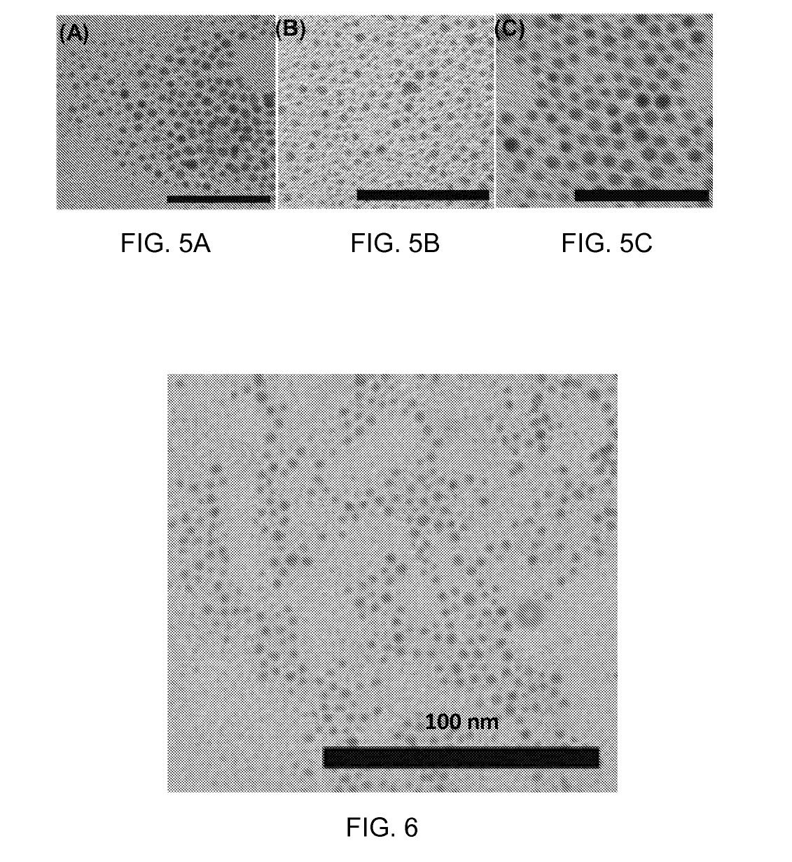

The ligand stabilized AuNPs were characterized by UV-visible spectroscopy. The MUA-capped particles display an absorption peak (λₘₐₓ) at 528 nm (FIG. 4). TEM analysis of the particles (FIG. 5A) shows that the MUA-capped nanoparticles are nearly monodisperse with an average size of 1.9±0.3 nm.

(C) MUOH-Capped Gold Nanaparticles

In another synthetic procedure, MUOH-capped gold nanoparticles were synthesized under similar reaction conditions and identical molar ratio of reagents as used in section (B). The ligand stabilized AuNPs were characterized by UV-visible spectroscopy. The MUOH-capped particles display an absorption peak (λₘₐₓ) at 517 nm (FIG. 4). TEM analysis of the particles (FIG. 6) shows that the MUOH-capped nanoparticles are nearly monodisperse with an average size of 2.0±0.3 nm.

(D) MUDA-Capped Gold Nanaparticles

In another synthetic procedure, MUDA-capped gold nanoparticles were synthesized under similar reaction conditions and identical molar ratio of reagents as used in section (B). The ligand stabilized AuNPs were characterized by UV-visible spectroscopy. The MUDA-capped particles display an absorption peak (λₘₐₓ) at 512 nm (FIG. 4). TEM analysis of the particles (FIG. 5B) shows that the MUDA-capped nanoparticles are nearly monodisperse with an average size of 1.4±0.2 nm.

(E) AUDDS-Capped Gold Nanaparticles

In another synthetic procedure, AUDDA-capped gold nanoparticles were synthesized under similar reaction conditions and identical molar ratio of reagents as used in section (B). The ligand stabilized AuNPs were characterized by UV-visible spectroscopy. The AUDDS-capped particles display an absorption peak (λₘₐₓ) at 529 nm (FIG. 4). TEM analysis of the particles (FIG. 5C) shows that the AUDDS-capped nanoparticles are nearly monodisperse with an average size of 2.2±0.3 nm.

A summary of the above ligand-capped gold nanoparticles is summarized in Table 1.

TABLE 1
Comparison of UV-visible absorption maxima and size
of gold nanoparticles synthesized in the presence of
different ω-functionalized alkylthiols.^{a}

| | UV-visible absorption | |
|---|---|---|
| | maximum | Particle size, |
| Samples | (λₘₐₓ) nm | nm^{b} |
| AuNPs-MUA | 528 | 1.9 (0.3) |
| AuNPs-MUDA | 512 | 1.4 (0.2) |
| AuNPs-MUOH | 517 | 2.0 (0.3) |
| AuNPs-AUDDS | 529 | 2.2 (0.3) |

^{a}In each case, at least 200 particles were counted to determine the size and the dispersity.
^{b}The number in parenthesis indicates the standard deviation.

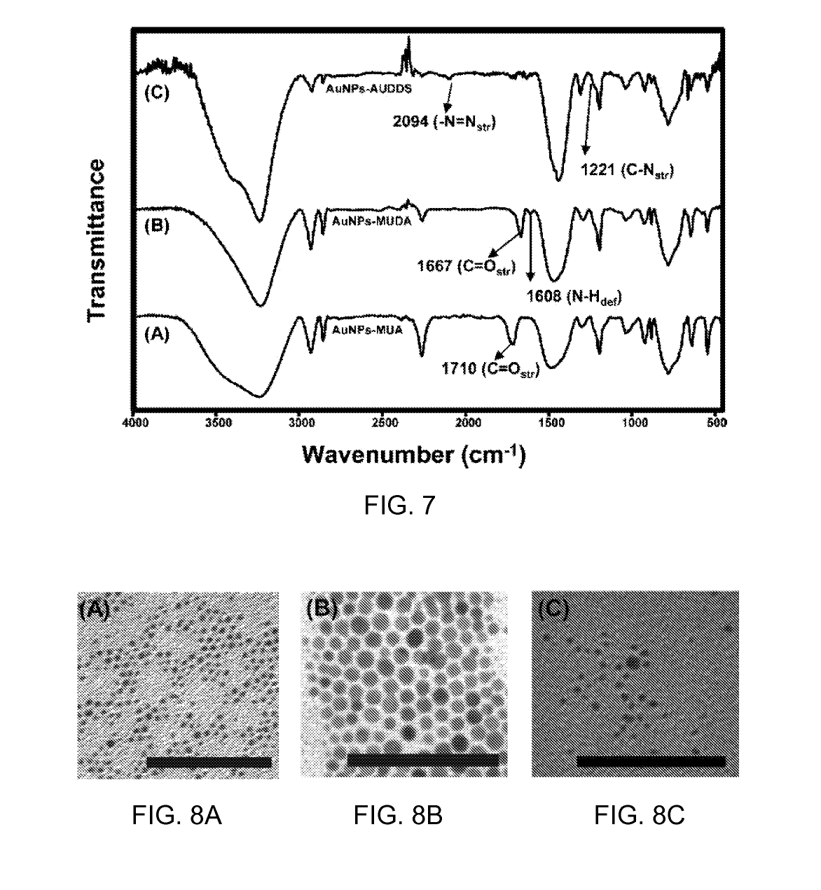

The ligand-stabilized AuNPs were further analyzed by FTIR to determine the nature of the functional groups on the ligands attached to the nanoparticle surface. The MUA- and MUDA-capped AuNP conjugates displayed absorption peaks at 1710 and 1667 cm⁻ which are assigned to CdO stretching in the —COOH and —CONH₂ of MUA and MUDA, respectively; see FIGS. 7A and 7B. In the case of MUDA-capped AuNPs, a peak at 1608 cm⁻¹ of sNsH stretching deformation was also observed. The azide terminated disulfide capped AuNPs display a peak at 2094 cm⁻ which is due to sNdN stretching of the sN₃ group, and additionally a shoulder at 1221 cm⁻¹ also appeared because of CsN stretching of CH₂sN₃ in FIG. 7C. The FTIR data shows that the functional groups attached to the nanoparticle surface are not altered and do not undergo chemical reduction by 9-BBN.

The 9-BBN reduction methodology provides a significant advantage in extending the range of functional groups used for AuNP surface functionalization in comparison to the Brust two-phase synthetic approach where the reduction reaction is not compatible with acid or alcohol terminated thiols. The AuNPs were synthesized in the presence of various functionalized thiols and produced particles in the size range of 1.4-3.3 nm without any postsynthesis treatment. The synthesized AuNPs can be purified by washing with cold hexane which allows removal of the soluble 9-BBN from the insoluble nanoparticles. Additional purification processes and large scale synthesis can also be used in connection with this approach.

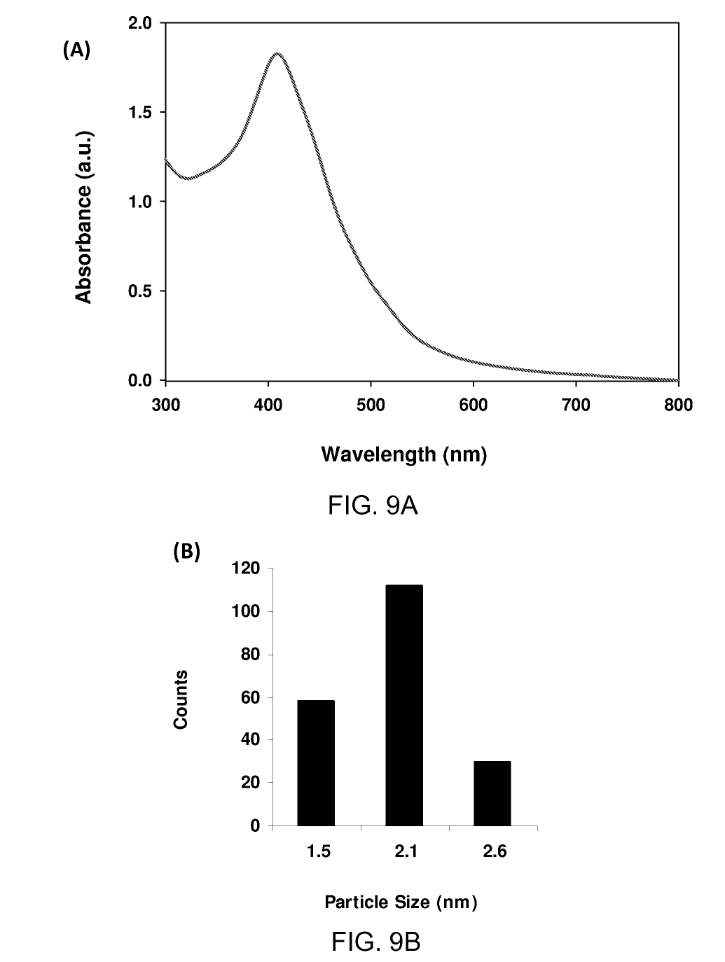

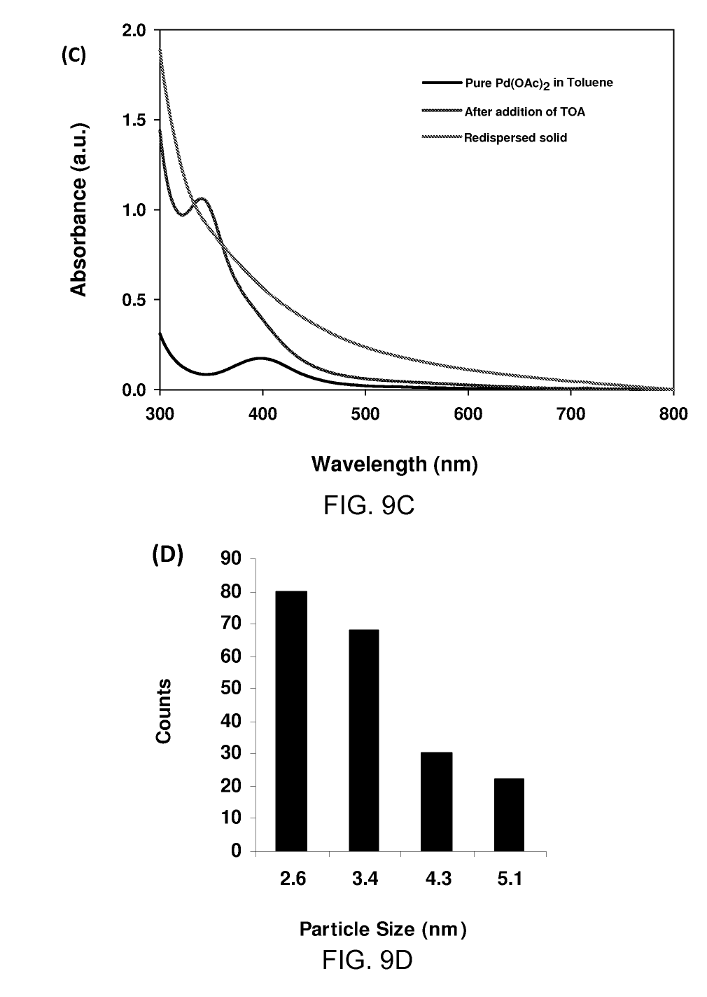

The versatility of the 9-BBN induced nanoparticle synthesis was also verified by applying this strategy to produce other noble metal nanoparticles. The surfactant stabilized nearly monodisperse silver, palladium, and platinum nanoparticles also were synthesized using 9-BBN as an efficient reducing agent. The sizes of the synthesized particles were 2.0±0.3, 3.4±0.9, and 1.7±0.4 nm for Ag, Pd, and Pt, respectively; see FIG. 8 and FIG. 9. A more detailed description of the synthetic protocols are included below.

Chemicals. Chloro(triethylphosphine) gold(I) (97%), silver heptafluorobutyrate (97%), palladium acetate (98%), potassium tetrachloroplatinate(II) (98%), 1-octadecanethiol (ODT, (98%), trioctylamine (TOA, 98%), 0.5 M THF solution of 9-Borabicyclo[3.3.1]nonane (9-BBN), 11-mercaptoundecanoic acid (MUA, 99%) and 11-mercapto-1-undecanol (MUOH, 99%) were purchased from Aldrich. 11-mercaptoundecanamide (MUDA, 99%) and azide-terminated undecyl disulfide (AUDDS, 99%) were obtained from Asemblon (Redmond, Wash.). HPLC grade toluene and ethanol were obtained form Fisher Scientific. All chemicals and solvents were used as received without additional purification. The glassware used in the synthesis was cleaned with aqua-regia, rinsed copiously with nanopure water, and dried over night prior to use. All reactions were carried out in air.

Spectroscopy and microscopy measurements. Absorption spectra (300 nm to 800 nm) were collected using a Perkin-Elmer Lambda 19 UV/Vis/NIR spectrophotometer. Transmission Electron Microscopy (TEM) micrographs were obtained using a Tecnai-12 instrument operating at 100 KV accelerating voltage. Before the TEM sample preparation, the sample was centrifuged at 4000 r.p.m for 10 minutes to remove any large aggregates. From the centrifuged solution, one drop of reaction mixture was deposited on a 150-mesh formvar-coated copper grid, and excess solution was removed by wicking with filter paper to avoid particle aggregation. The grid was then allowed to dry before being imaged. Particle size analysis was conducted by analyzing at least 200 particles in the TEM images using Scion Image Beta 4.02 Software. In Scion Image, after setting the known distance and unit, the ‘Analyze Particle’ parameter was used to generate a table of particle diameters. This table was then exported into Microsoft Excel 2003 for statistical analysis. In a similar way, the interparticle spacing was calculated by analyzing a minimum of 150 interparticle spacings. In the FTIR analysis, approximately 2 mg of dry solid samples were mixed with 100 mg of pregrind KBr and a minipress was used to prepare a transparent film.

### Example 2

### Synthesis of TOA-Stabilized Silver Nanoparticles

At room temperature, a clear homogeneous solution of 0.016 gm (0.05 mmol) of silver heptafluorobutyrate was prepared in 100-mL of toluene. In the solution, 0.13 mL (0.3 mmol) of trioctylamine (TOA) was injected and the solution was stirred for 30 minutes. At this point, 0.05 ml, of 0.5 M 9-BBN solution in THF was injected. After the addition of 9-BBN, the color of the solution was light yellow which became more intense over the period of 1 h of stirring at room temperature. The final solution was dark yellow and displayed a sharp peak (λₘₐₓ) at 408 nm in the UV-visible spectroscopy absorption spectrum. The solution was centrifuged and one drop was deposited on a formvar grid for TEM analysis.

### Example 3

### Synthesis of Ligand-Capped Palladium Nanoparticles

At room temperature, 0.011 gm (0.05 mmol) of Pd(OAc)₂ was dissolved in 100-mL of toluene which produce a light yellow colored homogeneous solution with a distinct peak (λₘₐₓ) at 398-nm in the UV-visible absorption spectrum. Into this solution, 0.13 mL (0.3 mmol) of TOA was added and the solution was heated to 60° C. for 30 minutes. After addition of TOA, the color of the solution became dark yellow and the peak in UV-visible spectra at 398-nm disappeared and a new peak (λₘₐₓ) at 340-nm appeared, which could be due to the formation of some palladium-amine complex. At this point, 0.4 mL of 0.5 M THF solution of 9-BBN was injected. After addition of 9-BBN, the color of the solution slowly changed from dark yellow to light brown and over the course of 2 hrs of heating, the solution was dark brown. As the solution was cooled down to room temperature, the brown solid precipitated out. The solution was centrifuged. The solid was redispersed in toluene in the presence of 0.3 mmol of ODT with stirring at room temperature for 2 hrs. At this point, most of the solid was dispersed in solution which became a dark brown color with no absorption maxima in the UV-visible spectrum. The solution was centrifuged to remove undissolved solid and from one drop of solution was deposited on a formvar grid for TEM analysis.

### Example 4

### Synthesis of TOA-Stabilized Platinum Nanoparticles

0.021 gm (0.05 mmol) of K₂PtCl₄ was transferred to a glass vial and 10-mL of DMF was added. The sample was then sonicated at room temperature until all of the solid dissolved, producing a light orange colored homogeneous solution. The solution was then transferred to a 250-mL erlenmeyer flask, diluted to 100-mL by adding 90-mL of toluene, and stirred for 30 minutes at 80° C. At this point, 0.13 mL (0.3 mmol) of TOA was added and the solution was stirred for 30 minutes. Then 0.4 mL of 0.5 M 9-BBN in THF was injected. Heating was continued for 8 hrs at 80° C. with constant stirring. After heating for 8 hrs, the solution was yellowish-brown. The solution was centrifuged to remove any large aggregates. One drop of the solution was deposited on a formvar coated carbon grid for TEM analysis.

In conclusion, Examples 1-4 show a single step efficient method of producing stabilized, nearly monodisperse, metal nanoparticles using 9-BBN as a reducing agent. The synthetic protocol based on this mild reducing agent provided the opportunity to directly functionalize AuNPs with a variety of thiolated ligands during the synthesis. The reducing agent also was used to synthesize ligand stabilized Ag, Pd, and Pt nanoparticles with low size dispersion.

### Example 5

### Synthesis of Triphenyplphosphine (TPP) Stabilized Gold Nanoparticles

Materials

Chloro(triethylphosphine)gold(I) (97%), triphenylphosphine (99%), trioctylphosphine (99.8%), 0.5 M THF solution of 9-Borabicyclo[3.3.1]nonane (9-BBN), 11-mercapto-1-undecanoic acid (MUA), 11-meracpto-1-undecanol(MuOH), 1-dodecanethiol (DDT) and toluene (HPLC grade) were obtained from Sigma Aldrich. Acetonitrile (HPLC grade) was obtained from Fisher Scientific. 11-bromo-1-undecanonethiol was obtained from Assemblon Inc. Dichloromethane (99.8%) was obtained from Fluka while hexanes were obtained from EMD Chemicals. Deuterated dichloromethane was obtained from Cambridge Isoptope Laboartories Inc. All the chemicals and solvents were used as received.

The gold organosols were synthesized when Et₃PAuCl (0.017 gm) was dissolved in to 50 mL of 1:4 acetonitrile-toluene containing TPP (0.0786 gm) and the reaction mixture was stirred for 30 minutes at room temperature. At this juncture, 0.4 mL of 0.5 M THF solution of 9-BBN was injected with constant stirring for another 30 minutes. At the end of the stirring, a black solid was obtained which was then centrifuged out, washed with hexanes and dried under N₂.

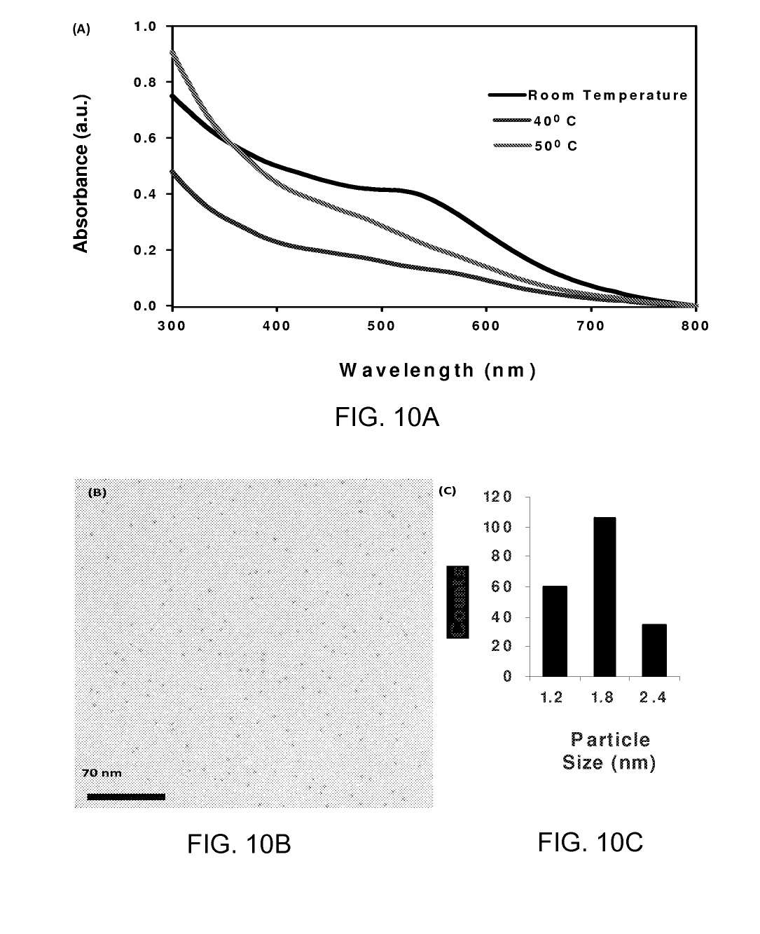

The final solid product could be redispersed either in dichloromethame (DCM) or acetonitrile for spectroscopic and microscopic analysis. UV-vis absorption spectra were collected at room temperature using a Perkin-Elmer Lambda 19 UV/Vis/NIR spectrophotometer. Transmission Electron Microscopy (TEM) micrographs were obtained using a Tecnai-12 instrument operating at 100 KV accelerating voltage. XPS data were obtained on a Kratos AxisUltraDLD using monochromatic Alka source. With a pass energy of 40 eV and a step size of 0.1 eV. The dwell time was 300 ms and the peaks were analyzed relative to the C1s peak at 285 eV. The amber colored solution displayed a shoulder centered ˜505 nm region in the UV-visible spectra, see FIG. 10A. The transmission electron microscopic (TEM) technique was used to determine the particle size. The analysis shows particles are narrowly dispersed with 1.7±0.4 nm in size, FIG. 10B.

Synthesis of triphenyplphosphine (TPP) Stabilized Gold Nanoparticles (AuNPs):

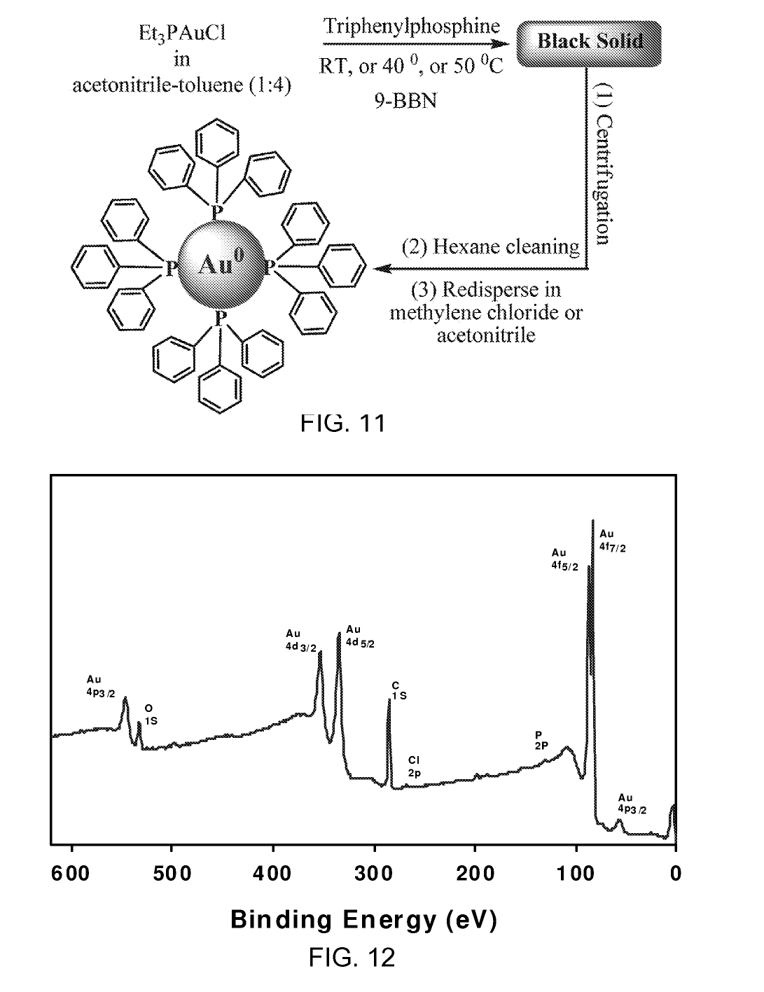

0.017 gm (0.05 mmol) of chloro(triethylphosphine)gold(I) (Et₃PAuCl) was dissolved in a mixture of acetonitrile and toluene (10 ml:40 ml). 0.0786 gms (0.3 mmol) of triphenylphosphine (TPP) were added to the mixture. At room temperature The contents were stirred for 30 minutes after which 0.4 ml of 9-BBN was injected into the mixture and 30 minutes of stirring results a reddish-purple color dispersion. The solution was centrifuged to washed twice with hexanes to remove any impurities. After drying the solid by nitrogen flow, a black color solid was obtained. Under identical molar ratio of reagents, reductions were also carried out at 40 or 50° C. The reaction scheme is shown in FIG. 11.

### Example 6

### Synthesis of Trioctylphosphine (TOP) Stabilized Gold Nanoparticles

0.017 gms (0.05 mM) of Et₃PAuCl was dissolved in a mixture of acetonitrile/toluene (10 ml/40 ml). 133.8 μl (0.3 mM) TOP was added to the mixture. The contents were stirred at room temperature for 30 minutes. 10 μl of TOA and 0.8 ml of 9-BBN were simultaneously injected into the mixture and the contents stirred. A total 9 hrs of stirring resulted fine dispersion, which was collected through centifugation, washed with hexane and analyzed by spectroscopic and microscopic techniques.

### Example 7

### Ligand Exchange of Triphenyplphosphine (TPP) Stabilized Gold Nanoparticles

TPP-AuNPs were prepared at room temperature as described in Example 5. The TPP-AuNPs then redispersed in dichloromethane (DCM). For the exchange reactions, different thiols such as, 11-mercapto-1-undecanoic acid (MUA), 11-meracpto-1-undecanol (MuOH), 1-dodecanethiol (DDT) were used. The TPP-AuNPs conjugates were dissolved in 20 mL solvent and in to it, 0.2 mM of the thiol was added. The mixtures were stirred for 30 minutes. After which the contents of the vials were centrifuged and the solid obtained dissolved in water. Brown colored solutions were obtained which were then analyzed by UV-Vis spectroscopy. MUA-AuNPs was trated with dilute NaoH to adjust the pH to ˜8. Each of the solution was deposited on a formvar copper grid for TEM analysis

The TEM analysis of AuNPs synthesized at room temperature are well dispersed on the grid; see FIG. 10B. This result suggests that the particles must be stabilized by TPP molecules which helps the particles to stay apart and prevent the aggregation. To validiate the TEM result, the AuNPs sample was analyzed by X-ray photoelectron spectroscopy (XPS) as shown in FIG. 12. The XPS spectra show all the gold peaks including the Au 4f. The peak position of gold 4f doublet, 4f_{5/2} (87.8 eV), 4f_{7/2} (84.1 eV), and the peak-to-peak distance (3.7 eV) clearly verifies that all the gold is present in Au⁰ oxidation state, because unreacted gold ions (Au) shows shoulder at 84.9 eV. In addition, the carbon 1s at 285.1 eV and oxygen is at 533 eV peaks are also observed. The peak at 131.6 eV is also detected which is due to coordinated P (2p) from TPP molecules. The XPS result shows the TPP stabilized AuNPs sample is 98% pure. The atomic composition of the TPP—stabilized gold nanoparticles is also determined from XPS data and the ratio of Au:P:Cl is found to be 20:2:1. The average molecular formula for the cluster was determined to be Au₁₄₆(PPh₃)₁₅Cl₇ by estimating that there ˜146 atoms in a particle of average size of 1.7 nm.

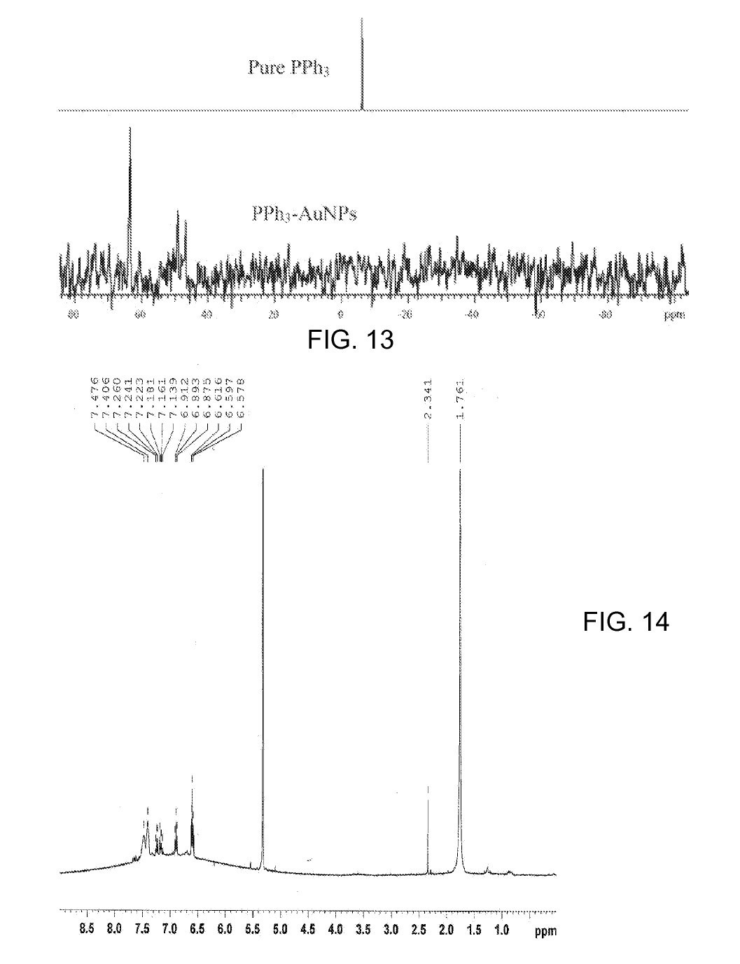

Additionally, the TPP-AuNPs were analyzed by NMR spectroscopy. NMR spectroscopy is a useful tool for obtaining information about the coordination chemistry of ligand-stabilized metal nanoparticles, particularly AuNPs. The synthesized particles were further analyzed by ³¹P NMR to confirm and support the XPS and TEM results that the AuNPs are stabilized by TPP molecules adsorbed on the surface. The NMR spectrum for pure TPP exhibited a peak at −5.4 ppm at room temperature. In comparison, the ³¹P NMR peak of TPP coordinated to the AuNPs is expected to be shifted downward. The synthesized TPP-AuNPs in CD₂Cl₂ did not exhibit a ³¹P NMR signal at room temperature or −5° C. A similar phenomenon also has been observed previously for gold clusters in the <2.0 nm size regime. After lowering the temperature to −55° C., a peak was observed at 63.0 ppm attributed to TPP coordinated to the AuNPs (FIG. 13). Previously, Creutz and co-workers described the chemical shift of phosphine-stabilized AuNPs with varying numbers of gold atoms. As the number of gold core atoms increases, it is expected that a downward shift of the ³¹P resonance of the AuNPs will be observed. Creutz and co-workers observed a chemical shift of 42.7 ppm for the Au101 cluster. In comparison, the Au146 cluster exhibited a chemical shift of 63.0 ppm. The single narrow peak at 63.0 ppm for TPP-AuNPs implies those phosphorus atoms are in a magnetically equivalent environment. The additional peaks in the region of 50-60 ppm could be due to the presence of triphenylphosphine oxide which may form as a result of the oxidation of TPP during sample preparation. The nanoparticles also were analyzed by ¹H NMR spectroscopy in order to determine their chemical composition. In the ¹H NMR spectrum (FIG. 14), broad peaks observed in the 7.2-7.4 ppm region are assigned to the protons from the phenyl rings of TPP adsorbed to the surface of the AuNPs. The absence of Et₃P methylene and terminal methyl protons resonances at ˜1.0 and 3.5 ppm, respectively, indicates that Et₃P is absent from the sample (FIG. 14). This confirms that the AuNPs are not stabilized by mixed ligands (TPP and Et₃P). The ¹H NMR spectrum also shows small peaks at 7.1 and 7.6 ppm, which could be due to traces of triphenylphosphine oxide. This result correlates with the ³¹P NMR spectrum where additional peaks were observed in the 50-60 ppm region.

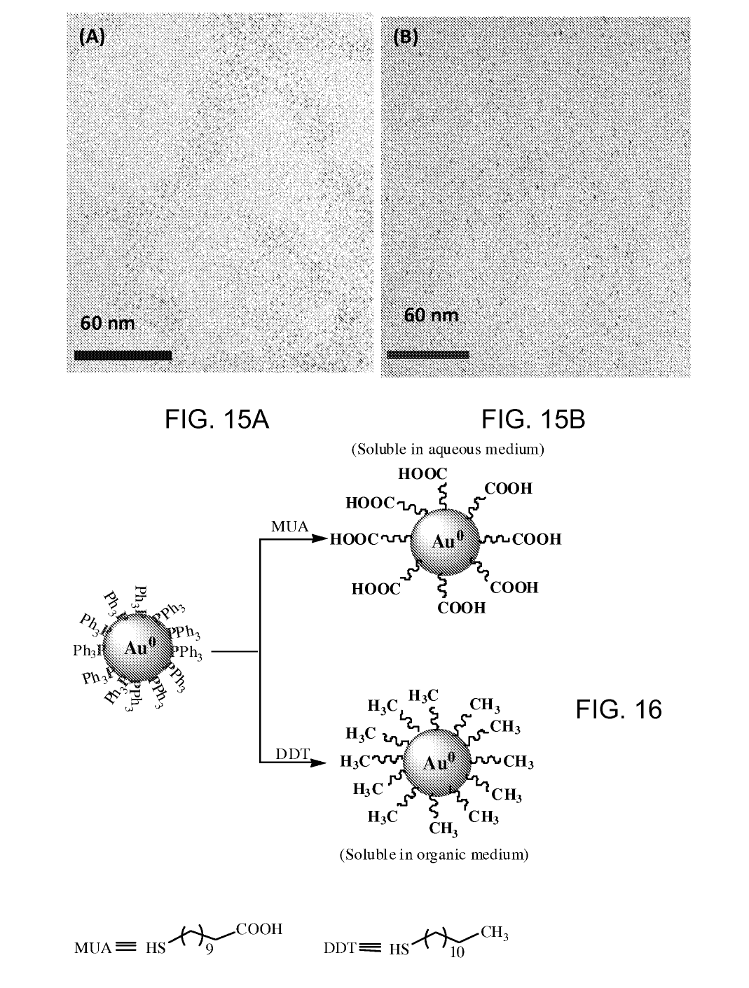

The approach described herein synthesizing various sizes AuNPs does not involve phase transfer step and the nanoparticles obtained are of narrow dispersity; e.g., (1.2 and 1.4 nm as described below). The very small size TPP stabilized AuNPs were synthesized by changing the solution temperature e.g. 40 and 50° C. The molar ratios of the reagents used in this synthesis were similar to the ones used for room temperature synthesis. After the reduction and purification steps a black color solid was obtained which was redispersed in DCM for subsequent different analysis. The UV-visible spectra of AuNPs synthesized at either 40 and 50° C. are featureless which indicated that the particles were very small in size with average diameter <1.5 nm. The samples were analysed by TEM and the representative TEM images for the TPP-stabilized AuNPs synthesized at 40 and 50° C. are shown in FIG. 15. The particles are of narrow dispersion with sizes of 1.4±0.2 nm and 1.2±0.2 nm respectively. Table 2 represents the comparison of UV-visible absorption maxima and size analysis of AuNPs synthesized as different temperature.

TABLE 2
Comparison of UV-visible absorption maxima and particle sizes
of TPP stabilized AuNPs synthesized at different temperature.

| | UV-visible | |
|---|---|---|
| temperature | absorption maxima | particle size |
| (° C.)^{a} | (nm) | (nm)^{b} |
| 25 | ~500 | 1.7 (0.4) |
| 40 | Featureless | 1.4 (0.2) |
| 50 | Featureless | 1.2 (0.2) |

^{a}25° C. represents room temperature.
^{b}The number in the parenthesis represents standard deviation.

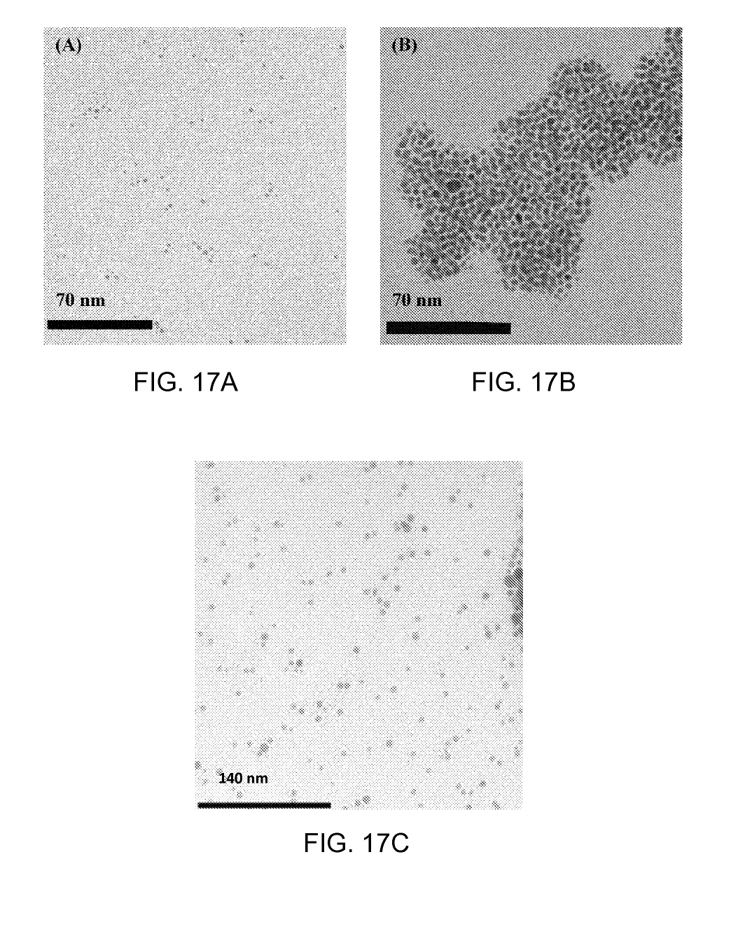

Either acid terminated or methyl terminated alkylthiols were used for the exchange reactions. An exemplary reaction scheme is provided in FIG. 16 for MUA and DDT. Based on the function group present in the thiols molecules, the new thiols-AuNPs conjugates are transferable either in aqueous or organic medium as shown in FIG. 16. The dodecanethiol (DDT) capped particles are stable in organic solvent and after post-exchange reaction, particle precipitation was not observed. The TEM analysis of the sample shows DDT capped particles are 1.7±0.7 nm in size, as shown in FIG. 17(A). 11-meracpto-1-undecanol (MuOH) capped particles are 2.1±0.4 nm, as shown in FIG. 17(C). As shown in FIG. 17(A), the particles are well-dispersed on the TEM grid. On the other hand, it was observed that the 11-mercapto-1-undecanoic acid (MUA) stabilized particles in organic medium are not stable and particle aggregation was detected. When the solid was collected and dissolved in water, it manifested as a three-dimensional network with an average particle size of 2.3±0.5 nm as shown in FIG. 17(B), which is presumably due to the either intra or inter-particles hydrogen bonding, further confirmed by FT-IR spectroscopy.

The pH of the MUA-AuNPs was adjusted to about pH 8 by addition of drops of dilute NaOH. Acid terminated thiol functionalised AuNPs forms large aggregates due to hydrogen bonding. In addition, if the aqueous solution of nanoparticles is adjusted to mild basic pH, the acid groups converted to carboxylate ions, which generate finely dispersed stable hydrosols. The MUA stabilized particles were separated from organic solvent by centrifugation and redispersed in water by adjusting the solution pH of 8-9. The TEM analysis of the aqueous AuNPs solution shows, particles are well dispersed with average size of 3.4±0.7 nm. The UV-vis spectra of the MUA-, MuOH and DDT-capped nanoparticles is typical of that observed for small gold clusters where the spectra shows little or no Plasmon resonance.

### Example 8

### Synthesis of TOP-stabilized Gold Nanoparticles

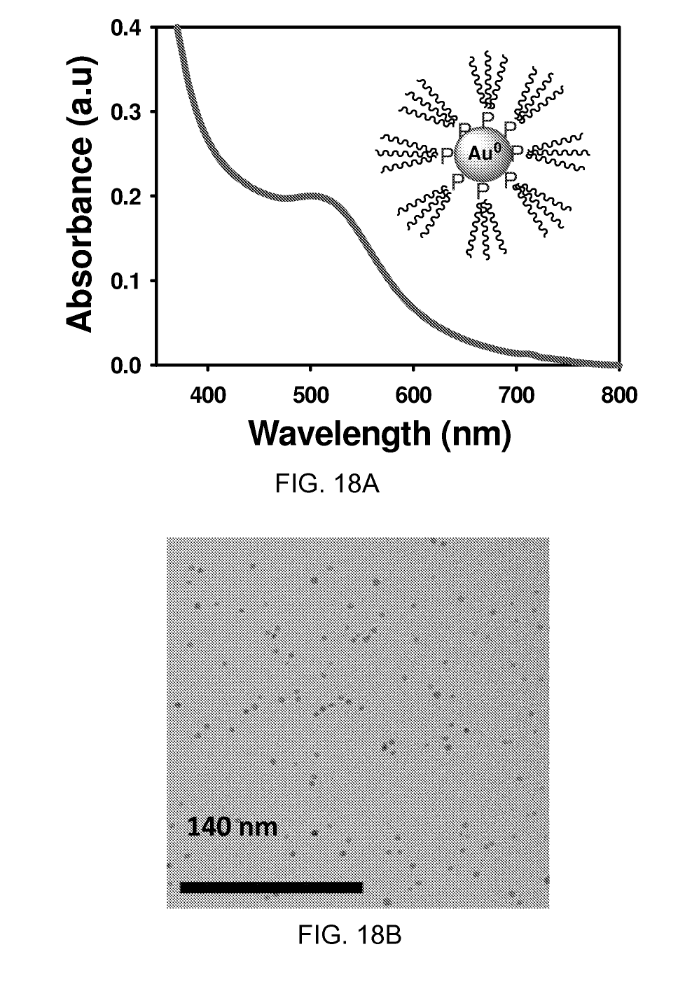

The versatility of the present synthetic method is further demonstrated by preparing nearly monodisperse AuNPs in the presence of trioctylphosphine (TOP) ligand. The synthesis was carried out at room temperature. An amount of 0.017 grams (0.05 mM) of Et₃PAuCl was dissolved in a mixture of acetonitrile:toluene (10:40 ml). An amount of 133.8 μl (0.3 mM) TOP was added to the mixture. The contents were stirred at room temperature for 30 minutes. An amount of 10 μl of TOA and 0.8 ml of 9-BBN were simultaneously injected into the mixture and the contents stirred. A total of 9 hrs of stirring resulted in a fine dispersion of particles, which was collected through centrifugation, washed with hexane and analyzed by spectroscopic and microscopic techniques. The UV-visible spectroscopic analysis of the particles in acetonitrile-toluene showed a peak (λₘₐₓ) at 505 nm region, FIG. 18. The size of the particles is 2.8±0.7 nm determined by TEM analysis (FIG. 18). The synthetic approach could be further extended to generate optically active multi-dented ligand stabilized AuNPs.

The mild reducing character of 9-BBN provides the opportunity to control the particle size. The slight tuning of the reduction conditions produces particles of 1.2-1.7 nm in diameter. These phosphine-stabilized gold nanoparticles can have their properties tuned by varying the diameter of the nanoparticles. This can be achieved by doing the synthesis at different temperatures and carefully controlling the molar ratios of the reactants.

The foregoing detailed description describes the invention with reference to specific exemplary embodiments. However, it will be appreciated that various modifications and changes can be made without departing from the scope of the present invention as set forth in the appended claims. The detailed description and accompanying drawings are to be regarded as merely illustrative, rather than as restrictive, and all such modifications or changes, if any, are intended to fall within the scope of the present invention as described and set forth herein.

What is claimed is:

1. A method of synthesizing ligand-capped metal nanoparticles, comprising reacting a metal salt with 9-borabicyclo [3.3.1] nonan as a reducing agent in the presence of a capping ligand to form the ligand-capped metal nanoparticles.

2. The method of claim 1, wherein the metal salt is selected from the group consisting of gold salts, palladium salts, platinum salts, silver salts, and combinations thereof.

3. The method of claim 2, wherein the metal salt is a gold salt selected from the group consisting of Et₃PAuCl, gold halides, gold cyanide, and combinations thereof.

4. The method of claim 2, wherein the metal salt is a palladium salt selected from the group consisting of palladium acetate, palladium chloride, tetrachloropalladate, and combinations thereof.

5. The method of claim 2, wherein the metal salt is a platinum salt selected from the group consisting of potassium tetrachloroplatinate(II), hexachloroplatinic(IV) acid hydrate, platinum chloride, and combinations thereof.

6. The method of claim 2, wherein the metal salt is a silver salt selected from the group consisting of silver silver heptafluorobutyrate, silver trifluoroacetate, silver acetate, and combinations thereof.

7. The method of claim 1, wherein the capping ligand is selected from the group consisting of functionalized alkyl thiols, azide disulfides, phosphines, bipyridines, and combinations thereof.

8. The method of claim 7, wherein the capping ligand includes an ω-functionalized group.

9. The method of claim 8, wherein the capping ligand is a functionalized alkyl thiol and the ω-functionalized group is an acid, amide, alcohol, or azide.

10. The method of claim 9, wherein the ω-functionalized group is selected from the group consisting of CH₃, COOH, OH, CONH₂, N₃, quaternary ammonium thiolate, ferrocene, and combinations thereof.

11. The method of claim 9, wherein the alkylthiol is selected from the group consisting of octadecanethiol, 11-mercaptoundecanoic acid, 11-mercapto-1-undecanoic acid, 11-mercaptoundecanamide, and combinations thereof.

12. The method of claim 9, wherein the co-functionalized alkylthiols are represented as HS—(CH₂)ₙ—X, where n is from 6 to 17 and X is —CH₃, —OH, —COOH, —CONH₂, —N₃, -ferrocene (Fc), or —NEt₃.

13. The method of claim 1, wherein the capping ligand is an azide disulfide selected from the group consisting of azide-terminated undecyl disulfide, and combinations thereof.

14. The method of claim 1, wherein the capping ligand is a phosphine selected from the group consisting of triphenylphosphine, trioctylphosphine, (S)-BINAP, (R)-BINAP, (R,R)—NORPHOS, (R,R)-DIOP, (S,S)-DIOP and combinations thereof.

15. The method of claim 1, wherein the capping ligand is a bipyridine or dithiol selected from the group consisting of 2,2′ bipyridyl, 2,4′ bipyridyl and 4,4′ bipyridyl, 2,2′-bithiophene and Bis(ethylenedithio) tetrathiafulvalene (BEDT-TTF), and combinations thereof.

16. The method of claim 1, wherein the metal nanoparticles are substantially free of capping ligands and the method further comprises stabilizing the nanoparticles in a solution including a stabilizing diluent.

17. The method of claim 16, wherein the stabilizing diluent is tetrahydrofuran (THF), acetonitrile (CH₃CN), or toluene.

18. The method of claim 1, wherein the reacting includes a catalyst.

19. The method of claim 18, wherein the catalyst is trioctylamine.

20. A material produced by the method of claim 1.

21. A collection of metal nanoparticles, comprising:
a) a plurality of metal nanoparticles functionalized with at least one capping ligand selected from the group consisting of alkyl thiols, azide disulfides, phosphines, bipyridines, and combinations thereof.

22. The collection of claim 21, wherein the collection is substantially monodisperse.
